(19) United States
(12) Patent Application Publication
(10) Pub. No.: US 2007/0055788 A1
(43) Pub. Date: Mar. 8, 2007

(54) Method for forwarding network file system requests and responses between network segments

(76) Inventors: Andrew Dunshea, Austin, TX (US); Agustin Mena III, Austin, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(21) Appl. No.: 11/201,657

(22) Filed: Aug. 11, 2005

(51) Int. Cl. G06F 15/16

(52) U.S. Cl. 709/232

(57) ABSTRACT

An improved method in a data processing system for forwarding network file system requests and responses between network segments. A notice is received that data has arrived at a receive buffer for a socket. The receive buffer is connected for the socket and a send buffer for another socket to form a splice. Both the socket and the other socket are flagged as a spliced connection.

### BACKGROUND OF THE INVENTION

1. Field of the Invention

The present invention relates generally to an improved data processing system, in particular, to a method, system, and computer program product for optimizing performance in a data processing system. Still more particularly, the present invention provides a method, system, and computer program product for forwarding network file system requests and responses between network segments.

2. Description of the Related Art

Network file system (NFS) is a protocol that allows a computer to access files over a network as if they were on its local disks. This protocol has been incorporated in products by more than two hundred companies, and is now a de facto standard. Most network file system implementations today use the User Datagram Protocol (UDP) or Transmission Control Protocol (TCP) network transports for communication between computer systems. UDP is a connectionless protocol which does not guarantee network packet delivery. As a result, UDP is lightweight and efficient, but all error processing and retransmission must be taken care of by the application program, in this case, network file system. TCP, on the other hand, is a reliable, connection-oriented protocol which does guarantee packet delivery, and which handles retransmission on behalf of the application. This solution applies to running network file system over TCP.

Problems exist for the efficient forwarding of network file system requests and responses between network segments with different configuration and performance characteristics. An example of an environment where such problems exist is one where there are three systems, a network file system server (server) system, a network file system client (client) system, and a network file system gateway (gateway) system. A server system is a network file system server with storage attached, the storage housing a local file system exported via network file system, or made available for access to external systems over the network via network file system. A client system is a network file system client where network file system mounts, or accesses, the file system exported by a server system. A gateway system is a network file system gateway node which communicates with both the server system and the client system, but on a different network segment for each. The server and gateway systems may be attached to a high-bandwidth backbone node. The client and gateway systems may be attached to a smaller, local area network where there may be more network file system client systems like CLNT. This environment allows for multiple gateway nodes between the server and client systems.

Problems exist for the known solutions in such an environment. The most common of the known solutions uses Transmission Control Protocol/Internet Protocol (TCP/IP) forwarding to allow communication between server and Client systems via the gateway node. In such a case, the gateway node is configured as an Open Systems Interconnection (OSI) level 3 router. A problem with this solution is that the performance may be limited by that of the slowest network segment. For example, packets transmitted from the client system to the server system that are dropped on the gateway-server segment must be retransmitted by the client system, which is typically connected by the slowest network segment. Another problem with this solution occurs when the detection of dropped packets is treated as an indication of congestion, such that the subsequent flow rates are reduced to avoid problems associated with the perceived congestion. Finally, client may not support all features supported by server and gateway, creating unnecessary limitations to the forwarding of network file system requests and responses.

A solution using Linux involves a gateway node network file system mounting the server-exported file system, and the gateway node re-exporting the file system so that the client system can network file system—mount it. This solution provides an opportunity to work around the limitation that network file system can only export local file systems. In Linux, both user-level and kernel-level network file system implementations are used in concert to achieve this. Many problems exist for this solution. Determining the right patch of Linux code to support this solution is difficult. The configuration of the kernel and user level components is not trivial. The performance penalty due to a large amount of code being exercised within both kernel and user level components is very high, as executing the additional code incurs extra path length for each packet.

The known solutions require either that the user sets up a router in the gateway node or patches Linux code in the gateway node.

### BRIEF DESCRIPTION OF THE DRAWINGS

The different aspects of present invention include an improved method, system, and computer program product in a data processing system for forwarding network file system requests and responses between network segments. A notice is received that data has arrived at a receive buffer for a socket. The receive buffer is connected for the socket and a send buffer for another socket to form a splice. Both the socket and the other socket are flagged as a spliced connection.

### BRIEF DESCRIPTION OF THE DRAWINGS

The novel features believed characteristic of the invention are set forth in the appended claims. The invention itself, however, as well as an illustrative mode of use, further objectives and advantages thereof, will best be understood by reference to the following detailed description of an illustrative embodiment when read in conjunction with the accompanying drawings, wherein:

FIG. 1 is a pictorial representation of network of a data processing system in which aspects of the present invention may be implemented, according to an illustrative embodiment of the present invention;

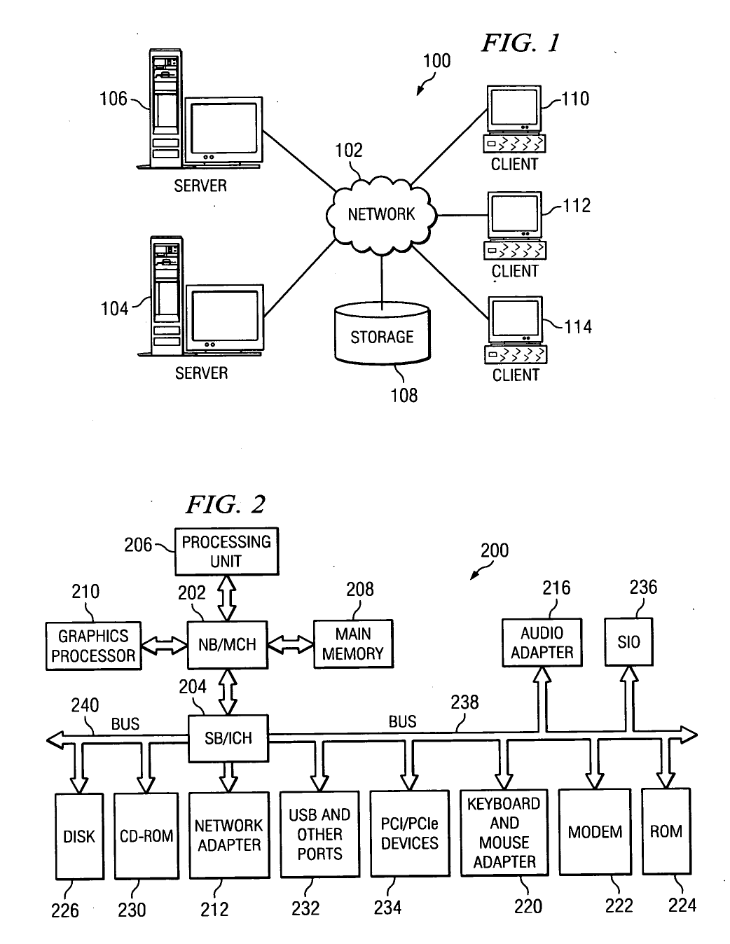

FIG. 2 is a block diagram of a data processing system in which aspects of the present invention may be implemented, according to an illustrative embodiment of the present invention;

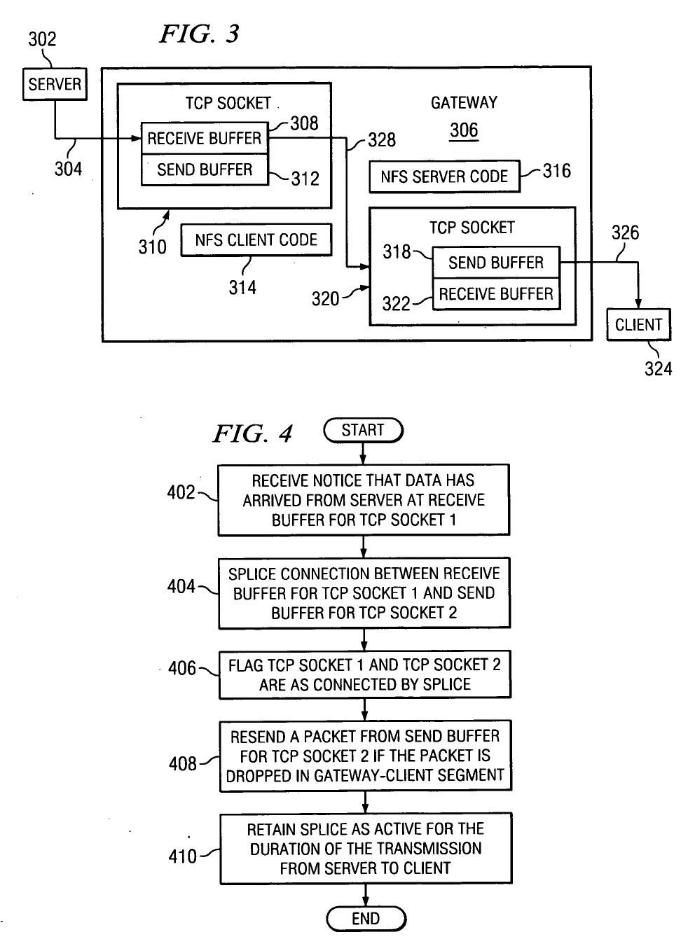

FIG. 3 is a block diagram illustrating examples of components used for forwarding network file system requests and responses between network segments, according to an illustrative embodiment of the present invention; and

FIG. 4 is a flowchart illustrating a process used for forwarding network file system requests and responses between network segments, according to an illustrative embodiment of the present invention.

### DETAILED DESCRIPTION OF THE PREFERRED EMBODIMENT

FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments of the present invention.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 202 and south bridge and input/output (I/O) controller hub (ICH) 204. Processing unit 206, main memory 208, and graphics processor 210 are connected to north bridge and memory controller hub 202. Graphics processor 210 may be connected to north bridge and memory controller hub 202 through an accelerated graphics port (AGP).

In the depicted example, local area network (LAN) adapter 212 connects to south bridge and -I/O controller hub 204. Audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 204 through bus 238 and bus 240. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 204 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 204.

An operating system runs on processing unit 206 and coordinates and provides control of various components within data processing system 200 in FIG. 2. As a client, the operating system may be a commercially available operating system such as Advanced Interactive Executive (AIX®), Microsoft® Windows® XP, UNIX®, or Linux® (AIX is a registered trademark of International Business Machines Corporation in the United States, other countries, or both; Microsoft and Windows are registered trademarks of Microsoft Corporation in the United States, other countries, or both; UNIX is a registered trademark of the Open Group in the United States, other countries, or both; while Linux is a registered trademark of Linus Torvalds in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, and pSeries are trademarks of International Business Machines Corporation in the United States, other countries). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as hard disk drive 226, and may be loaded into main memory 208 for execution by processing unit 206. The processes for embodiments of the present invention are performed by processing unit 206 using computer usable program code, which may be located in a memory such as, for example, main memory 208, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 208, read only memory 224, or a cache such as found in north bridge and memory controller hub 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Embodiments of this invention use a method known as splicing within the gateway node(s) to enable communication between the server and client systems. One feature that the embodiments of this invention provide is that the routers with the slowest network segment do not limit performance between the end points of the server and client systems. Another feature is that packets dropped between systems on a network client would only require retransmission over that segment. An additional feature is that the flow rate is not reduced because the detection of dropped packets is not treated as an indication of congestion. One more feature is that the forwarding of network file system requests and responses are not restricted by lack of client features. A further feature is that configuration is fairly straightforward, as no user level intervention on the gateway node is required.

FIG. 3 is a block diagram illustrating examples of components used for forwarding network file system requests and responses between network elements according to an illustrative embodiment of the present invention. Components illustrated in FIG. 3 may be implemented using components depicted in FIG. 1. For example, server 302 may be implemented by server 104, client 324 may be implemented by client 110, client 112, or client 114, and gateway node 306 may be implemented anywhere in Network 102.

Creating a splice on the gateway node(s) allows the most efficient network usage on the network segment(s) between the server and client systems. Creating a splice means to join directly together two or more paths to make a direct path for data to flow, in effect bypassing potential paths that are longer paths. An example in a clustered environment is where gateway node 306 may be on a very high-speed bandwidth backbone network 304 with the lower speed client 324 also connected to gateway node 306 through a different interface on a smaller local area network 426. The transfer of data from the server 302 to gateway node 306 will be on the high performance network 304 utilizing the most appropriate network option, including TCP and maximum transmission unit (MTU) send/receive spaces. The data will be staged or buffered on intermediary gateway node 306 and sent out efficiently to the lower speed client 324.

This staging or buffering, apart from making efficient use of network and CPU resources from server 302 point of view, improves the performance for lower speed client 324 as intermediary gateway node 306 is able to stage or buffer data and allow streaming to the end client 324 at a rate best-suited on that network segment 326.

Referencing FIG. 3 components, FIG. 4 is a flowchart illustrating a process used for forwarding network file system requests and responses between network segments, according to an illustrative embodiment of the present invention. Implementing embodiments of the invention may be accomplished by a small modification to network file system client code 314 and network file system server code 316 on gateway node 306. As an example of a network file system response, server 302 sends data over server-gateway segment 304 to gateway node 306, the data arrives at gateway node 306 through TCP socket 310 and is stored in receive buffer 308 for TCP socket 310. Network file system client code 314 receives notice that data has arrived from server 302 at receive buffer 308 for TCP socket 310 (step 402).

To provide for the features found in the illustrative embodiments of the present invention, network file system client code 314 bypasses the code to read the data, process the data, and pass the data to network file system server code 316 on gateway node 306. Network file system client code 314 splices connection 328 between receive buffer 308 for TCP socket 310 and send buffer 318 for TCP socket 320, where TCP socket 320 is a socket connection already established with the requesting client, client 324 (step 404). TCP socket 310 and TCP socket 320 are both flagged as connected by splice 328 (step 406) so that other transmissions do not attempt to use or splice the sockets already spliced until the spliced transmission is completed. Then, without further recourse to network file system client code 314 and network file system server code 316, server 302 sends data to receive buffer 308 for TCP socket 310, which is spliced to send buffer 318 for TCP socket 320, from where the data is sent to client 324. If a packet is dropped in gateway-client segment 326, the packet is resent from send buffer 318 for TCP socket 320, not all the way from server 302 (step 408). Splice 328 is retained as active for the duration of the transmission from server 302 to client 324 (step 410).

As an example of a network file system request, when network file system server code 316 on gateway node 306 detects an incoming mount request from client 324 for a directory which is actually exported from server 302, the network file system server code forwards this request to server 302. The socket connection established to server 302 will be spliced by splice 328 with the socket connection established already with the client 324. If required, note that this would allow multiple intermediary gateway nodes because client 324 will not be able to distinguish between a direct connection to server 302 and a staged or buffered connection through gateway node 306.

Splicing in the illustrative examples may be implemented through a number different options. For example, in user space a system call to splice passes the user space addresses of the sockets to be spliced, such as socket 1 and socket 2, such that the user space addresses are converted to kernel space parameters. Another option is in kernel space, where a kernel splice call provides the two addresses in kernel space to be spliced. A kernel splice call is executed at the level of an operating system, such as Unix®. Although it has to be executed at the level of the operating system, a kernel splice call has an advantage over a user space system call because the addresses of the sockets to be spliced are passed using kernel space parameters, such that these addresses do not require conversion. These options splice the two connections, link the sockets in each direction, and flag each connection as a splice connection.

Altogether, the components and process as shown in FIGS. 3 and 4 provide an improved method, apparatus, and computer usable program code for propagation of filter expressions across multi-layered systems.

The invention can take the form of an entirely hardware embodiment, an entirely software embodiment, or an embodiment containing both hardware and software elements. In an illustrative embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor, a solid-state memory, a magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for forwarding network file system requests and responses between network segments, the computer implemented method comprising:
detecting an arrival of data at a receive buffer for a first socket, wherein the first socket is for a connection with a server; and
responsive to detecting the arrival of data at the receive buffer for the first socket, connecting the receive buffer for the first socket and a send buffer for a second socket to form a splice, wherein the second socket is for an already existing connection with a client and wherein the splice is used to form a connection between the server and the client.

2. The computer implemented method of claim 1 further comprising:
flagging both the first socket and the second socket as a spliced connection.

3. The computer implemented method of claim 1 further comprising:
responsive to data being dropped, resending data from the send buffer for the second socket.

4. The computer implemented method of claim 1 further comprising:
retaining the splice for a duration of a connection.

5. The computer implemented method of claim 1 wherein the connecting step comprises:
passing a user space address of the first socket to be spliced and a user space address of the second socket to be spliced through a splice system call in user space;
converting the pair of user space addresses to a pair of kernel space parameters;
connecting the first socket to the second socket to form a splice;
linking the first socket to the second socket through a link in the first socket; and
linking the second socket to the first socket through a second link in the second socket.

6. The computer implemented method of claim 1 wherein the connecting step comprises:
passing a kernel space address of the first socket to be spliced and a user space address of the second socket to be spliced through a kernel splice call in kernel space;
connecting the first socket to the second socket to form a splice;
linking the first socket to the second socket through a link in the first socket; and
linking the second socket to the first socket through a second link in the second socket.

7. The computer implemented method of claim 1 wherein the detecting step and the connecting step are performed in a gateway.

8. A data processing system for forwarding network file system requests and responses between network segments, comprising:
a bus;
a storage device connected to the bus, wherein the storage device comprises computer usable code;
a communications unit connected to the bus; and
a processing unit connected to the bus, wherein the processing unit executes the computer usable code to detect an arrival of data at a receive buffer for a first socket, wherein the first socket is for a connection with a server, and connect the receive buffer for the first socket and a send buffer for a second socket to form a splice, wherein the second socket is for an already existing connection with a client and wherein the splice is used to form a connection between the server and the client, responsive to detecting the arrival of data at the receive buffer for the first socket.

9. The data processing system of claim 8 further comprising:
computer usable code to flag both the first socket and the second socket as a spliced connection.

10. The data processing system of claim 8 further comprising:
computer usable code to resend data from the send buffer for the second socket, responsive to data being dropped.

11. The data processing system of claim 8 further comprising:
computer usable code to retain the splice for a duration of a connection.

12. The data processing system of claim 8 wherein the connecting step comprises:
passing a user space address of the first socket to be spliced and a user space address of the second socket to be spliced through a splice system call in user space;
converting the pair of user space addresses to a pair of kernel space parameters;
connecting the first socket to the second socket to form a splice;
linking the first socket to the second socket through a link in the first socket; and
linking the second socket to the first socket through a second link in the second socket.

13. The data processing system of claim 8 wherein the connecting step comprises:
passing a kernel space address of the first socket to be spliced and a user space address of the second socket to be spliced through a kernel splice call in kernel space;
connecting the first socket to the second socket to form a splice;
linking the first socket to the second socket through a link in the first socket; and
linking the second socket to the first socket through a second link in the second socket.

14. The data processing system of claim 8 wherein the detecting step and the connecting step are performed in a gateway.

15. A computer program product for forwarding network file system requests and responses between network segments, the computer program product comprising:
a computer usable medium having computer usable program code embodied therein;
computer usable program code configured to detect an arrival of data at a receive buffer for a first socket, wherein the first socket is for a connection with a server; and
computer usable program code configured to connect the receive buffer for the first socket and a send buffer for a second socket to form a splice, wherein the second socket is for an already existing connection with a client and wherein the splice is used to form a connection between the server and the client, responsive to detecting the arrival of data at the receive buffer for the first socket.

16. The computer program product of claim 15 further comprising:
computer usable program code configured to flag both the first socket and the second socket as a spliced connection.

17. The computer program product of claim 15 further comprising:
responsive to data being dropped, computer usable program code configured to resend data from the send buffer for the second socket.

18. The computer program product of claim 15 further comprising:
computer usable program code configured to retain the splice for a duration of a connection.

19. The computer program product of claim 15 wherein the connecting step comprises:
passing a user space address of the first socket to be spliced and a user space address of the second socket to be spliced through a splice system call in user space;
converting the pair of user space addresses to a pair of kernel space parameters;
connecting the first socket to the second socket to form a splice;
linking the first socket to the second socket through a link in the first socket; and
linking the second socket to the first socket through a second link in the second socket.

20. The computer program product of claim 15 wherein the connecting step comprises:
passing a kernel space address of the first socket to be spliced and a user space address of the second socket to be spliced through a kernel splice call in kernel space;
connecting the first socket to the second socket to form a splice;
linking the first socket to the second socket through a link in the first socket; and
linking the second socket to the first socket through a second link in the second socket.
